(19) United States
(12) Patent Application Publication
(10) Pub. No.: US 2012/0051431 A1
(43) Pub. Date: Mar. 1, 2012

(54) MOTION DIRECTION BASED ADAPTIVE MOTION VECTOR RESOLUTION SIGNALING FOR VIDEO CODING

(75) Inventors: Wei-Jung Chien, San Diego, CA (US); Marta Karczewicz, San Diego, CA (US); Peisong Chen, San Diego, CA (US)

(73) Assignee: QUALCOMM INCORPORATED, San Diego, CA (US)

(21) Appl. No.: 13/172,496

(22) Filed: Jun. 29, 2011

Related U.S. Application Data
(60) Provisional application No. 61/376,808, filed on Aug. 25, 2010.

(51) Int. Cl. H04N 7/26

(52) U.S. Cl. 375/240.16; 375/E07.125

(57) ABSTRACT

Video coding devices may signal or determine sub-integer pixel precision for motion vectors based on a direction of prediction for the motion vector, e.g., whether a reference frame is to be displayed earlier or later than a current frame. In one example, an apparatus includes a video encoder configured to encode a block of video data using a motion vector that refers to a reference frame in one of a plurality of sets of reference frames with a selected sub-integer pixel precision, generate a value representative of the selected precision for the motion vector based on the one of the plurality of sets of reference frames referred to by the motion vector, and output the encoded block and the generated value representative of the selected precision for the motion vector. A video decoder may determine a sub-integer pixel precision for the motion vector based on the value.

This application claims the benefit of U.S. Provisional Application No. 61/376,808, filed Aug. 25, 2010, which is hereby incorporated by reference in its entirety.

### TECHNICAL FIELD

This disclosure relates to video coding and, more particularly, inter-predictive video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards and standard proposals defined by MPEG-2, MPEG-4, ITU-T H.263 or ITU-T H.264/MPEG-4, Part 10, Advanced Video Coding (AVC), High Efficiency Video Coding (HEVC), and extensions of such standards and standards proposals, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

### SUMMARY

In general, this disclosure describes techniques for supporting adaptive motion vector resolution during video coding, e.g., adaptive motion vector resolution selection for motion estimation and motion compensation. For example, a video encoder may be configured to select different levels of sub-integer pixel precision, e.g., either one-eighth pixel precision or one-quarter pixel precision, when encoding a block of video data. That is, a motion vector for the block produced by the video encoder may have one-eighth pixel precision or one-quarter pixel precision, based on the selection. The video encoder may signal selection of one-eighth pixel precision or one-quarter pixel precision for the motion vector using the techniques of this disclosure. In some examples, a value indicating whether a motion vector has one-eighth pixel precision or one-quarter pixel precision may also represent a reference frame list (e.g., list 0 or list 1) in which a reference frame to which the motion vector points is found.

In one example, a method of encoding video data includes encoding a block of video data using a motion vector that refers to a reference frame in one of a plurality of sets of reference frames with a selected sub-integer pixel precision, generating a value representative of the selected sub-integer pixel precision for the motion vector based on the one of the plurality of sets of reference frames referred to by the motion vector; and outputting the encoded block and the generated value representative of the selected sub-integer pixel precision for the motion vector.

In another example, an apparatus for encoding video data includes a video encoder configured to encode a block of video data using a motion vector that refers to a reference frame in one of a plurality of sets of reference frames with a selected sub-integer pixel precision, generate a value representative of the selected sub-integer pixel precision for the motion vector based on the one of the plurality of sets of reference frames referred to by the motion vector, and output the encoded block and the generated value representative of the selected sub-integer pixel precision for the motion vector.

In another example, an apparatus for encoding video data includes means for encoding a block of video data using a motion vector that refers to a reference frame in one of a plurality of sets of reference frames with a selected sub-integer pixel precision, means for generating a value representative of the selected sub-integer pixel precision for the motion vector based on the one of the plurality of sets of reference frames referred to by the motion vector, and means for outputting the encoded block and the generated value representative of the selected sub-integer pixel precision for the motion vector.

In another example, a computer program product includes a computer-readable medium having stored thereon instructions that, when executed, cause a processor of a device for encoding video data to encode a block of video data using a motion vector that refers to a reference frame in one of a plurality of sets of reference frames with a selected sub-integer pixel precision, generate a value representative of the selected sub-integer pixel precision for the motion vector based on the one of the plurality of sets of reference frames referred to by the motion vector, and output the encoded block and the generated value representative of the selected sub-integer pixel precision for the motion vector.

In another example, a method of decoding video data includes receiving an encoded block of video data, a motion vector for the encoded block of video data, and a value corresponding to the motion vector, wherein the motion vector refers to a reference frame in one of a plurality of sets of reference frames, determining a sub-integer pixel precision for the motion vector and the one of the plurality of sets of reference frames based on the received value corresponding to the motion vector, and decoding the encoded block of video data relative to the reference frame in the determined one of the plurality of sets of reference frames using the motion vector, based on the determined sub-integer pixel precision for the motion vector.

In another example, an apparatus for decoding video data includes a video decoder configured to receive an encoded block of video data, a motion vector for the encoded block of video data, and a value corresponding to the motion vector, wherein the motion vector refers to a reference frame in one of a plurality of sets of reference frames, determine a sub-integer pixel precision for the motion vector and the one of the plurality of sets of reference frames based on the received value corresponding to the motion vector, and decode the encoded block of video data relative to the reference frame in the determined one of the plurality of sets of reference frames using the motion vector, based on the determined sub-integer pixel precision for the motion vector.

In another example, an apparatus for decoding video data includes means for receiving an encoded block of video data, a motion vector for the encoded block of video data, and a value corresponding to the motion vector, wherein the motion vector refers to a reference frame in one of a plurality of sets of reference frames, means for determining a sub-integer pixel precision for the motion vector and the one of the plurality of sets of reference frames based on the received value corresponding to the motion vector, and means for decoding the encoded block of video data relative to the reference frame in the determined one of the plurality of sets of reference frames using the motion vector, based on the determined sub-integer pixel precision for the motion vector.

In another example, a computer program product includes a computer-readable medium having stored thereon instructions that, when executed, cause a processor of a device for decoding video data to receive an encoded block of video data, a motion vector for the encoded block of video data, and a value corresponding to the motion vector, wherein the motion vector refers to a reference frame in one of a plurality of sets of reference frames, determine a sub-integer pixel precision for the motion vector and the one of the plurality of sets of reference frames based on the received value corresponding to the motion vector, and decode the encoded block of video data relative to the reference frame in the determined one of the plurality of sets of reference frames using the motion vector, based on the determined sub-integer pixel precision for the motion vector.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for signaling sub-integer pixel precision of motion vectors based on motion direction.

FIG. 2 is a block diagram illustrating an example of a video encoder that may implement techniques for signaling sub-integer pixel precision of motion vectors based on motion direction.

FIG. 3 is a block diagram illustrating an example of a video decoder, which decodes an encoded video sequence using techniques for determining sub-integer pixel precision of motion vectors based on motion direction.

FIG. 4 is a conceptual diagram illustrating sub-integer pixel positions for a full pixel position.

FIG. 5 is a conceptual diagram illustrating a sequence of coded video frames.

FIG. 6 is a conceptual diagram illustrating a current frame including blocks predicted from reference blocks of a display order previous frame and a display order subsequent frame.

FIG. 7 is a flowchart illustrating an example method for providing an indication of a sub-integer pixel precision for a motion vector based on motion direction of the motion vector.

FIG. 8 is a flowchart illustrating an example method for decoding video data including indications of motion vector precision based on motion direction.

FIG. 9 is a flowchart illustrating an example method for adapting a VLC table based on statistics for symbols encoded using the VLC table.

### DETAILED DESCRIPTION

In general, this disclosure describes techniques for adaptively selecting motion vector precision for motion vectors used to encode blocks of video data, and signaling the selected motion vector precision for the motion vectors. The techniques may include adaptively selecting between different levels of sub-integer pixel precision, sometimes referred to as fractional pixel precision. For example, the techniques may include adaptively selecting between one-quarter pixel precision and one-eighth pixel precision for motion vectors used to encode blocks of video data. The term “eighth-pixel” precision in this disclosure is intended to refer to precision of one-eighth (⅛^{th}) of a pixel, e.g., one of: the full pixel position ( 0/8), one-eighth of a pixel (⅛), two-eighths of a pixel ( 2/8, also one-quarter of a pixel), three-eighths of a pixel (⅜), four-eighths of a pixel ( 4/8, also one-half of a pixel and two-quarters of a pixel), five-eighths of a pixel (⅝), six-eighths of a pixel ( 6/8, also three-quarters of a pixel), or seven-eighths of a pixel (⅞).

Conventional H.264 encoders and decoders support motion vectors having one-quarter-pixel precision. In some instances, one-eighth-pixel precision may provide certain advantages over one-quarter-pixel precision. However, encoding every motion vector to one-eighth-pixel precision may require too many coding bits that may outweigh the benefits of one-eighth-pixel precision motion vectors. The techniques of this disclosure include using one-eighth-pixel precision motion vectors when appropriate, otherwise using one-quarter-pixel precision motion vectors, and signaling whether a motion vector has one-eighth-pixel precision or one-quarter-pixel precision, so that a decoder may determine the precision used by the encoder for particular blocks.

To avoid adding a full bit for each motion vector as a flag indicating whether the motion vector has one-quarter or one-eighth pixel precision, this disclosure proposes combining the signaling of the precision of the motion vector with a signal indicating a set of reference frames to which the motion vector points. For example, in H.264, reference frames that are to be displayed before a current frame are stored in reference frame list labeled “list 0.” Likewise, reference frames that are to be displayed after the current frame are stored in a reference frame list labeled “list 1.” In either case, a motion vector may include a signal indicating an index into the corresponding list, where the list corresponds to a reference frame of the list. In this manner, a single value may be used to indicate which of the two sets the motion vector refers to, as well as whether the motion vector has one-quarter or one-eighth pixel precision.

As an example, the value may correspond to a variable length codeword (VLC) of a VLC table. The VLC table may include codewords corresponding to a variety of combinations of motion vector precisions and corresponding lists. In this manner, shorter codewords may be assigned to more likely combinations of motion vector precision (e.g., one-eighth pixel precision or one-quarter pixel precision) and list selection (e.g., reference picture list 0 or list 1) for a motion vector, while longer codwords may be assigned to less likely combinations of precision and list selection. The relative likelihoods may be determined empirically using a set of training data. In some examples, the relative likelihoods may be adaptively modified over time, e.g., based on analysis of occurrences of combinations of motion vector precision and reference frame lists.

As noted above, list 0 typically includes reference frames having a display time earlier than the current frame, while list 1 typically includes reference frames having a display time later than the current frame. Whether a motion vector refers to a frame in list 0 or list 1 may be described as “motion direction.” That is, the phrase motion direction may be used to refer to whether a motion vector refers to a reference frame having a display time earlier or later than the current frame to be coded. Accordingly, the techniques of this disclosure may include signaling the sub-integer pixel precision of a motion vector based on a motion direction. Moreover, the techniques of this disclosure may include signaling both a motion direction and a sub-integer pixel precision for a motion vector using a common value, e.g., a VLC codeword.

Although H.264 defines list 0 as a list of reference frames having display orders earlier than a current frame and list 1 as a list of reference frames having display orders later than the current frame, it should be understood that other examples are possible as well. In general, a video encoder may manipulate the frames in either or both list in any way. The video encoder may signal how either or both of the lists have been (or are to be) modified in, e.g., header data for a slice, frame, group of frames (or group of pictures), or in other locations, e.g., in a picture parameter set or a sequence parameter set. In some examples, the two lists may include identical sets of reference frames, e.g., to allow for generalized B frames. Blocks of generalized B frames may be predicted from two reference frames in the same temporal direction, e.g., two reference frames having an earlier display time than a current block being encoded of a current frame, or two reference frames having a later display time than the current block. Although the techniques of this disclosure are generally described with the assumption that list 0 includes display order previous frames and list 1 includes display order subsequent frames, it should be understood that the techniques of this disclosure are not limited to this assumption, but may be directed to other scenarios as well, such as where list 0 and list 1 include identical reference frames.

VLC tables may be constructed in accordance with the techniques of this disclosure to include codewords representative of both a motion direction (for example, whether a motion vector refers to a reference frame in list 0 or list 1) and a sub-integer pixel precision for the motion vector. Data for the motion vector may further include an index into the list of reference frames corresponding to the codeword selected for the motion vector. However, this index may be separate from the codeword representative of motion direction and sub-integer pixel precision for the motion vector. A motion vector may further include a horizontal component and a vertical component. In this manner, a motion vector may be described by a horizontal component, a vertical component, a list identifier, an index into the list, and an indication of sub-integer pixel precision. In accordance with the techniques of this disclosure, the list identifier (also referred to as motion direction) and the indication of sub-integer pixel precision may be represented by the same codeword. In this manner, a value indicative of the sub-integer pixel precision may be selected based on motion direction for the motion vector.

Moreover, in some examples, blocks of video data are encoded using bi-directional prediction. A bi-directionally predicted block may include a first motion vector referring to a reference frame in list 0 and a second motion vector referring to a reference frame in list 1. The motion direction for such a block may therefore be described as bi-directional. Accordingly, motion direction may also describe whether a block has one or two motion vectors, and when only one motion vector, whether the motion vector refers to a reference frame of list 0 or list 1. In accordance with the techniques of this disclosure, a codeword may be selected to signal whether a block is encoded using one or two motion vectors, as well as sub-integer pixel precisions for each of the motion vectors. When a block is bi-directionally predicted, the motion vectors for the block need not necessarily have the same sub-integer pixel precision, and therefore, the selected codeword may indicate the selected precision for each of the two motion vectors.

Table 1 below provides an example of a VLC table that may be used to encode motion direction (that is, a list identifier) and sub-integer pixel precision for motion vectors of blocks. The first column of Table 1 provides a codeword for a block, the second column describes the motion direction for the block (whether list 0, list 1, or bi-directional), the third column provides an indication of the precision of the first motion vector for the block (the only motion vector if the block is uni-directionally predicted, or the motion vector referring to list 0 if the block is bi-directionally predicted), and the fourth column provides an indication of the precision of the second motion vector for the block (only when bi-directionally predicted, “N/A” meaning that the block is uni-directionally predicted and thus has no second motion vector). The codeword may be provided as a signaled value for a block, e.g., in a block header.

TABLE 1

| Codeword | Motion Direction | MV1 Precision | MV2 Precision |
|---|---|---|---|
| 0 | List 0 | ¼ pel | N/A |
| 01 | List 1 | ¼ pel | N/A |
| 001 | Bi-directional | ¼ pel | ¼ pel |
| 0001 | List 0 | ⅛ pel | N/A |
| 00001 | List 1 | ⅛ pel | N/A |
| 000001 | Bi-directional | ⅛ pel | ⅛ pel |
| 0000001 | Bi-directional | ⅛ pel | ¼ pel |
| 0000000 | Bi-directional | ¼ pel | ⅛ pel |

Table 2 below provides an alternative example.

TABLE 2

| Codeword | Motion Direction | MV1 Precision | MV2 Precision |
|---|---|---|---|
| 000 | List 0 | ¼ pel | N/A |
| 010 | List 1 | ¼ pel | N/A |
| 001 | List 0 | ⅛ pel | N/A |
| 011 | List 1 | ⅛ pel | N/A |
| 11 | Bi-directional | ¼ pel | ¼ pel |
| 101 | Bi-directional | ⅛ pel | ⅛ pel |
| 1001 | Bi-directional | ⅛ pel | ¼ pel |
| 10001 | Bi-directional | ¼ pel | ⅛ pel |

In some examples, statistics may be gathered for a slice or frame regarding the occurrence of motion direction and sub-integer pixel precision for motion vectors of blocks in the slice or frame. Using these statistics, a VLC table for the slice or frame may be updated for a subsequent slice or frame. For example, initially, motion direction and sub-integer pixel precision for motion vectors of blocks of a slice may be encoded using the VLC table of Table 1 above. Then, based on statistics gathered for the slice, the table may be updated to resemble the example of Table 3 below.

In this example, it is assumed that blocks that are bi-directionally predicted with motion vectors both having ⅛ pixel precision are less common in the slice than blocks that are bi-directionally predicted where the motion vectors have different sub-integer pixel precisions (e.g., one motion vector has ⅛ pixel precision while the other motion vector has ¼ pixel precision). Moreover, it is assumed in this example that the occurrence of a bi-directionally predicted block where the list 0 motion vector has ¼ pixel precision and the list 1 motion vector has ⅛ pixel precision is more common than the occurrence of a bi-directionally predicted block where the list 1 motion vector has ¼ pixel precision and the list 0 motion vector has ⅛ pixel precision. Therefore, the codewords assigned to these scenarios are updated such that relatively more likely combinations of motion direction and sub-integer pixel precision are assigned shorter codewords than relatively less likely combinations. Again, the likelihood of combinations may be calculated for the current frame or slice such that the VLC table can be updated for a subsequent frame or slice.

TABLE 3

| Codeword | Motion Direction | MV1 Precision | MV2 Precision |
|---|---|---|---|
| 0 | List 0 | ¼ pel | N/A |
| 01 | List 1 | ¼ pel | N/A |
| 001 | Bi-directional | ¼ pel | ¼ pel |
| 0001 | List 0 | ⅛ pel | N/A |
| 00001 | List 1 | ⅛ pel | N/A |
| 000001 | Bi-directional | ¼ pel | ⅛ pel |
| 0000001 | Bi-directional | ⅛ pel | ¼ pel |
| 0000000 | Bi-directional | ⅛ pel | ⅛ pel |

In still other examples, the codeword indicative of sub-integer pixel precision of motion vectors for blocks may be assigned simply based on motion direction, but need not necessarily also indicate motion direction. In such cases, a separate indicator of motion direction may be provided, which indicates whether a block is uni-directionally predicted (and if so, whether the motion vector for the block refers to list 0 or list 1) or bi-directionally predicted. If the block is uni-directionally predicted, regardless of which list is referred to by the motion vector, the codeword may be assigned according to Table 4 below.

TABLE 4

| Codeword | MV Precision |
|---|---|
| 0 | ⅛ pel |
| 1 | ¼ pel |

Continuing with the example above, if the block is bi-directionally predicted, the codeword indicative of precision for the motion vectors may be assigned according to Table 5 below.

TABLE 5

| Codeword | List 0 MV Precision | List 1 MV Precision |
|---|---|---|
| 1 | ¼ pel | ¼ pel |
| 01 | ⅛ pel | ⅛ pel |
| 001 | ¼ pel | ⅛ pel |
| 000 | ⅛ pel | ¼ pel |

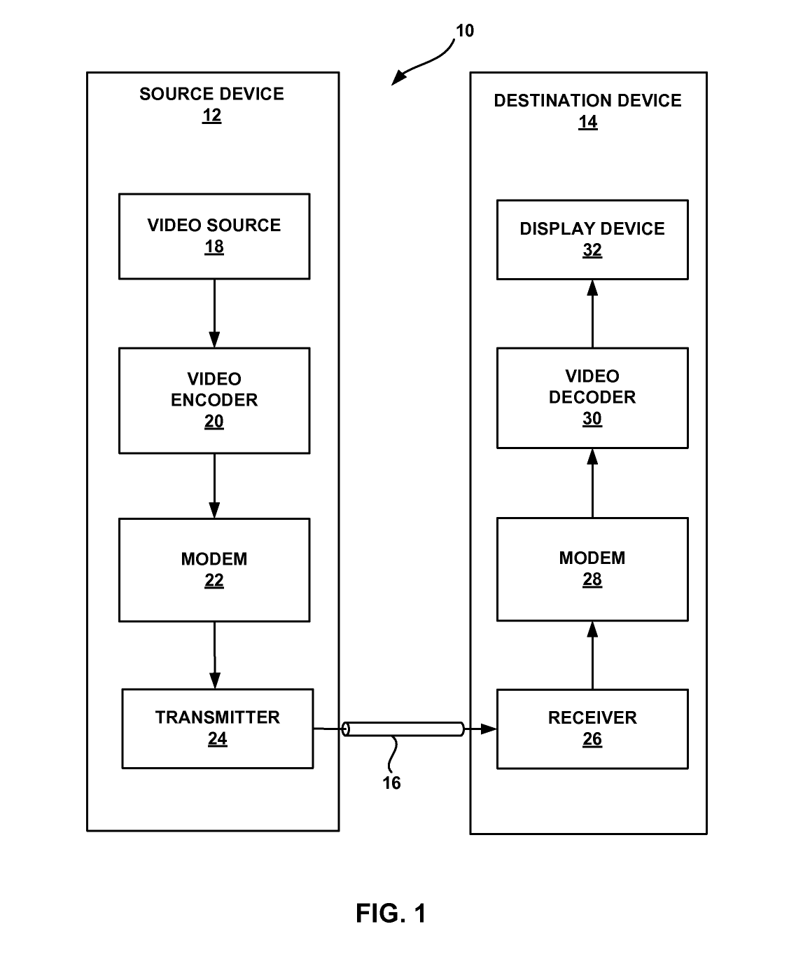

FIG. 1 is a block diagram illustrating an example video encoding and decoding system 10 that may utilize techniques for signaling sub-integer pixel precision of motion vectors based on motion direction. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless. The techniques of this disclosure, however, which concern signaling sub-integer pixel precision of motion vectors based on motion direction, are not necessarily limited to wireless applications or settings. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 may be configured to apply the techniques for signaling sub-integer pixel precision of motion vectors based on motion direction. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for signaling sub-integer pixel precision of motion vectors based on motion direction may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process may implement one or more of the techniques described herein for signaling sub-integer pixel precision of motion vectors based on motion direction. The information communicated over channel 16 may include syntax information defined by video encoder 20, which is also used by video decoder 30, that includes syntax elements that describe characteristics and/or processing of macroblocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” may refer to any independently decodable unit of a video frame such as an entire frame, a slice of a frame, a group of pictures (GOP) also referred to as a sequence, or another independently decodable unit defined according to applicable coding techniques.

Efforts are currently in progress to develop a new video coding standard, currently referred to as High Efficiency Video Coding (HEVC). The upcoming standard is also referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-three intra-prediction encoding modes. The techniques of this disclosure may also apply to video encoders substantially conforming to HEVC.

HM refers to a block of video data as a coding unit (CU). Syntax data within a bitstream may define a largest coding unit (LCU), which is a largest coding unit in terms of the number of pixels. In general, a CU has a similar purpose to a macroblock of H.264, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be split into sub-CUs. Syntax data for a bitstream may define a maximum number of times an LCU may be split, referred to as CU depth. Accordingly, a bitstream may also define a smallest coding unit (SCU). This disclosure also uses the term “block” to refer to any of a CU, PU, or TU.

An LCU may be associated with a quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A CU that is not split may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the PU(s) may also describe, for example, partitioning of the CU into one or more PUs. Partitioning modes may differ between whether the CU is uncoded, intra-prediction mode encoded, or inter-prediction mode encoded.

A CU having one or more PUs may also include one or more transform units (TUs). Following prediction using a PU, a video encoder may calculate a residual value for the portion of the CU corresponding to the PU. The residual value may be transformed, scanned, and quantized. A TU is not necessarily limited to the size of a PU. Thus, TUs may be larger or smaller than corresponding PUs for the same CU. In some examples, the maximum size of a TU may correspond to the size of the corresponding CU.

In accordance with the techniques of this disclosure, video encoder 20 may adaptively select a sub-integer pixel precision for motion vectors used to inter-prediction encode blocks of video data. The blocks may comprise macroblocks or partitions of macroblocks in the example of H.264, or PUs of CUs in the example of HEVC. Moreover, video encoder 20 may signal sub-integer pixel precision for motion vectors used to encode blocks of video data, e.g., whether a motion vector has one-quarter pixel precision or one-eighth pixel precision. In accordance with the techniques of this disclosure, video encoder 20 may signal the selected sub-integer pixel precision of a motion vector based at least in part on whether the motion vector refers to a reference frame having a display time earlier than the current frame being encoded, or to a reference frame having a display time later than the current frame being encoded.

In one example, video encoder 20 may determine one of a plurality of sets of reference frames to which a motion vector refers. The plurality of sets of reference frames may include two lists of reference frames: list 0, which includes reference frames having display times earlier than the current frame, and list 1, which includes reference frames having display times later than the current frame. Video encoder 20 may further include a set of values, such as a variable length code (VLC) table, representative of various combinations of motion vector sub-integer pixel precisions and sets of reference frames to which a motion vector may refer. The VLC table may be constructed such that bit lengths for the values generally correspond to probabilities of the combinations occurring. For example, if the most likely combination is a motion vector having one-quarter pixel precision referring to a reference frame in list 0, the shortest codeword in the VLC table may represent the combination of a motion vector having one-quarter pixel precision referring to a reference frame in list 0.

In some examples, video encoder 20 may be configured to adapt the VLC table during encoding of a frame. For example, video encoder 20 may determine numbers of occurrences for the various combinations when encoding a frame. Then, based on these numbers, video encoder 20 may modify a current VLC table such that the modified VLC table includes values having bit lengths representative of probabilities of occurrence of the various combinations of sub-integer pixel precision for a motion vector and sets of reference frames to which the motion vector refers.

Video encoder 20 may be configured to select a sub-integer pixel precision for a motion vector by comparing rate-distortion values for encoding a block using a motion vector having one-quarter pixel precision and encoding the block using a motion vector having one-eighth pixel precision. Video encoder 20 may use the motion vector of the selected precision to encode the block of the current frame. In particular, video encoder 20 may retrieve predictive data for the block from the reference frame referred to by the motion vector at the location of the reference frame indicated by the motion vector. Video encoder 20 may then calculate a residual value for the block and encode the residual value. Video encoder 20 may further provide signaling data indicative of the selected precision for the motion vector, e.g., in header data for the block (e.g., header data for a macroblock comprising the block for H.264, or in a quadtree corresponding to a CU comprising the block for HEVC).

Following intra-predictive or inter-predictive coding to produce predictive data and residual data, and following any transforms (such as the 4×4 or 8×8 integer transform used in H.264/AVC or a discrete cosine transform DCT) to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, macroblock type, coding mode, maximum macroblock size for a coded unit (such as a frame, slice, macroblock, or sequence), or the like.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame. Video decoder 30 may also perform techniques for interpreting signaling of sub-integer pixel precision for motion vectors based on motion direction. Video decoder 30 may be configured to determine sub-integer pixel precision of motion vectors based on motion direction using signal data provided by video encoder 20.

In some examples, video decoder 30 may be configured to retrieve the signaled data for a block to determine a sub-integer pixel precision for a motion vector used to encode the block. The signaled data may comprise an indication of the sub-integer pixel precision based on one of a plurality of sets of reference frames to which the motion vector refers. In some examples, the signaled data may comprise a codeword selected from a VLC table that represents both the sub-integer pixel precision of a motion vector for the block and an indication of which of the sets of reference frames the motion vector refers to. For example, the codeword may represent a sub-integer pixel precision for the motion vector, as well as an indication of whether the motion vector refers to a reference frame in list 0 or list 1. Video decoder 30 may use the motion vector to decode the block in a process generally symmetric to the process used by video encoder 20 to encode the block.

Video encoder 20 and video decoder 30 may each store VLC tables that generally include the same correspondence of codewords to motion vector sub-integer pixel precision. When video encoder 20 is configured to adapt its VLC table based on statistics, video decoder 30 may also be configured to adapt its VLC table in a similar manner. In other examples, video encoder 20 may transmit a copy of the updated VLC table to video decoder 30, e.g., as part of the same bitstream or as side information in a separate bitstream.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

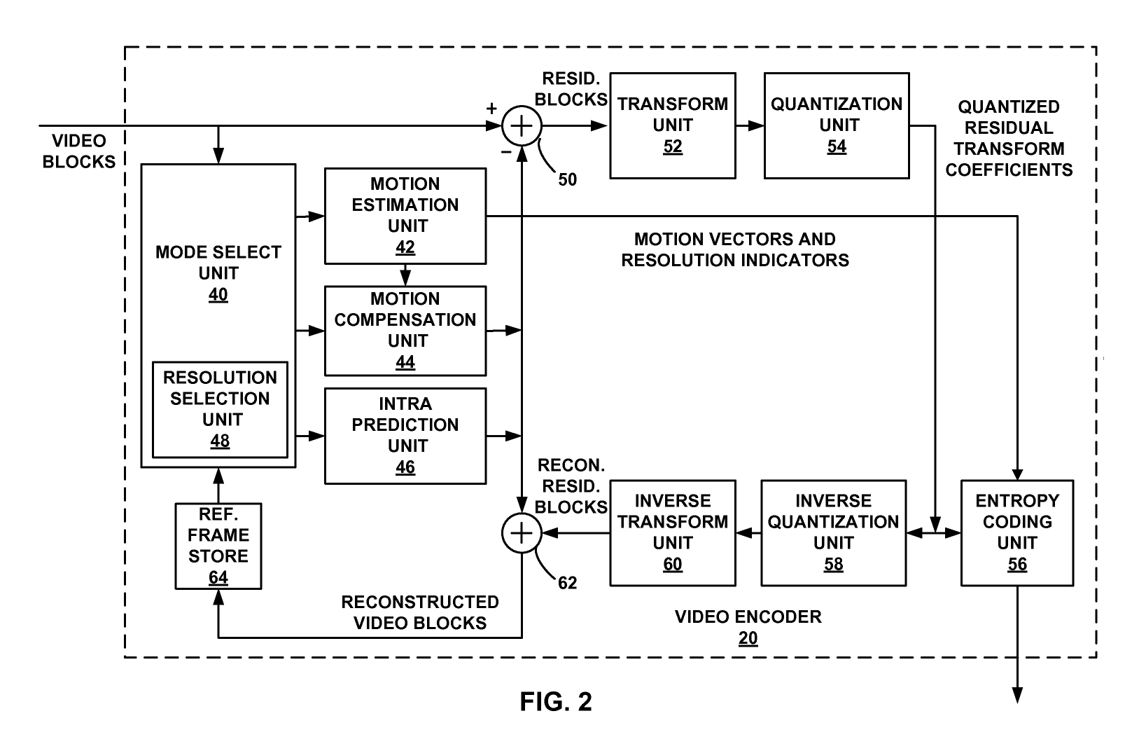

FIG. 2 is a block diagram illustrating an example of video encoder 20 that may implement techniques for signaling sub-integer pixel precision of motion vectors based on motion direction. Video encoder 20 may perform intra- and inter-coding of blocks within video frames, including macroblocks, or partitions or sub-partitions of macroblocks. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes and inter-modes such as uni-directional prediction (P-mode) or bi-directional prediction (B-mode) may refer to any of several temporal-based compression modes. Although components for inter-mode encoding are depicted in FIG. 2, it should be understood that video encoder 20 may further include components for intra-mode encoding. However, such components are not illustrated for the sake of brevity and clarity.

As shown in FIG. 2, video encoder 20 receives a current video block within a video frame to be encoded. In the example of FIG. 2, video encoder 20 includes motion compensation unit 44, motion estimation unit 42, reference frame store 64, summer 50, transform unit 52, quantization unit 54, and entropy coding unit 56. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. An intra prediction unit 46 may also perform intra-predictive coding of the received video block relative to one or more neighboring blocks in the same frame or slice as the block to be coded to provide spatial compression.

Mode select unit 40 may select one of the coding modes, intra or inter, e.g., based on error results. When mode select unit 40 selects inter-mode encoding for a block, resolution selection unit 48 may select a resolution for a motion vector for the block. For example, resolution selection unit 48 may select one-eighth-pixel precision or one-quarter-pixel precision for a motion vector for the block.

As an example, resolution selection unit 48 may be configured to compare an error difference between using a one-quarter-pixel precision motion vector to encode a block and using a one-eighth-pixel precision motion vector to encode the block. Motion estimation unit 42 may be configured to encode a block using one or more quarter-pixel precision motion vectors in a first coding pass and one or more eighth-pixel precision motion vectors in a second coding pass. Motion estimation unit 42 may further use a variety of combinations of one or more quarter-pixel precision motion vectors and one or more eighth-pixel precision motion vectors for the block in a third encoding pass. Resolution selection unit 48 may calculate rate-distortion values for each encoding pass of the block and calculate differences between the rate-distortion values.

When the difference exceeds a threshold, resolution selection unit 48 may select the one-eighth-pixel precision motion vector for encoding the block. Resolution selection unit 48 may also evaluate rate-distortion information, analyze a bit budget, or analyze other factors to determine whether to use one-eighth-pixel precision or one-quarter-pixel precision for a motion vector when encoding a block during an inter-mode prediction process. After selecting one-eighth-pixel precision or one-quarter-pixel precision for a block to be inter-mode encoded, mode select unit 40 or motion estimation may send a message (e.g., a signal) to motion estimation unit 42 indicative of the selected precision for a motion vector.

Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a macroblock. Motion compensation may involve fetching or generating the predictive block based on the motion vector determined by motion estimation. Again, motion estimation unit 42 and motion compensation unit 44 may be functionally integrated, in some examples.

Motion estimation unit 42 calculates a motion vector for the video block of an inter-coded frame by comparing the video block to video blocks of a reference frame in reference frame store 64. Motion compensation unit 44 may also interpolate sub-integer pixels of the reference frame, e.g., an I-frame or a P-frame, to support sub-integer motion vector precision. The ITU H.264 standard, as an example, describes two lists: list 0, which includes reference frames having a display order earlier than a current frame being encoded, and list 1, which includes reference frames having a display order later than the current frame being encoded. Therefore, data stored in reference frame store 64 may be organized according to these lists.

Motion estimation unit 42 compares blocks of one or more reference frames from reference frame store 64 to a block to be encoded of a current frame, e.g., a P-frame or a B-frame. When the reference frames in reference frame store 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in reference frame store 64 if no values for sub-integer pixel positions are stored in reference frame store 64. Motion estimation unit 42 sends the calculated motion vector to entropy coding unit 56 and motion compensation unit 44. The reference frame block identified by a motion vector may be referred to as a predictive block. Motion compensation unit 44 calculates error values for the predictive block of the reference frame.

Motion estimation unit 42, motion compensation unit 44, mode select unit 40, or another unit of video encoder 20, may also signal the use of one-quarter-pixel precision or one-eighth-pixel precision for a motion vector used to encode a block. For example, motion estimation unit 42 may send an indication of a sub-integer pixel precision for the motion vector to entropy coding unit 56, as well as an indication of the set of reference frames of reference frame store 64 (e.g., list 0 or list 1) in which the reference frame referred to by the motion vector is stored.

In accordance with the techniques of this disclosure, entropy coding unit 56 may be configured to signal whether a motion vector has one-quarter pixel precision or one-eighth pixel precision using a value based on (and in some examples, that also indicates) whether the frame including the block to which the motion vector points is stored in list 0 or list 1 of reference frame store 64. Alternatively, other units of video encoder 20 may be configured to generate a value indicative of whether a motion vector has one-eighth pixel precision or one-quarter pixel precision based on whether the motion vector refers to list 0 or list 1, such as motion estimation unit 42.

Motion compensation unit 44 may calculate prediction data based on the predictive block. Video encoder 20 forms a residual video block by subtracting the prediction data from motion compensation unit 44 from the original video block being coded. Summer 50 represents the component or components that perform this subtraction operation. Transform unit 52 applies a transform, such as a discrete cosine transform (DCT) or a conceptually similar transform, to the residual block, producing a video block comprising residual transform coefficient values. Transform unit 52 may perform other transforms, such as those defined by the H.264 standard, which are conceptually similar to DCT. Wavelet transforms, integer transforms, sub-band transforms or other types of transforms could also be used. In any case, transform unit 52 applies the transform to the residual block, producing a block of residual transform coefficients. The transform may convert the residual information from a pixel value domain to a transform domain, such as a frequency domain. Quantization unit 54 quantizes the residual transform coefficients to further reduce bit rate. The quantization process may reduce the bit depth associated with some or all of the coefficients. The degree of quantization may be modified by adjusting a quantization parameter.

Following quantization, entropy coding unit 56 entropy codes the quantized transform coefficients. For example, entropy coding unit 56 may perform content adaptive variable length coding (CAVLC), context adaptive binary arithmetic coding (CABAC), or another entropy coding technique. Following the entropy coding by entropy coding unit 56, the encoded video may be transmitted to another device or archived for later transmission or retrieval. In the case of context adaptive binary arithmetic coding, context may be based on neighboring macroblocks.

In some cases, entropy coding unit 56 or another unit of video encoder 20 may be configured to perform other coding functions, in addition to entropy coding. For example, entropy coding unit 56 may be configured to determine CBP values for macroblocks and partitions of macroblocks. Also, in some cases, entropy coding unit 56 may perform run length coding of the coefficients in a macroblock or partition thereof. In particular, entropy coding unit 56 may apply a zig-zag scan or other scan pattern to scan the transform coefficients in a macroblock or partition and encode runs of zeros for further compression. Entropy coding unit 56 also may construct header information with appropriate syntax elements for transmission in the encoded video bitstream.

In accordance with the techniques of this disclosure, entropy coding unit 56 may store a VLC table (not shown) that includes correspondence between codewords and indications of sub-integer pixel precision for motion vectors of coded blocks based on motion direction. As discussed above, “motion direction” may refer to whether a block is inter-prediction encoded relative to a reference frame having a display time earlier than a current frame including the inter-prediction encoded block (e.g., in list 0 of reference frame store 64), relative to a reference frame having a display time later than the current frame (e.g., in list 1 of reference frame store 64), or bi-directionally predicted relative to both a reference frame having a display time earlier than the current frame and a reference frame having a display time later than the current frame. The sub-integer pixel precisions for motion vectors of a bi-directionally predicted block need not necessarily be the same. Therefore, the VLC table stored by entropy coding unit 56 may include codewords representative of all possible combinations of motion direction and sub-integer pixel precision, as shown in the examples of Tables 1-5 above.

Entropy coding unit 56 may further be configured to calculate statistics for occurrences of the various combinations of motion direction and sub-integer pixel precision for motion vectors used to encode blocks of a slice. Based on these statistics, entropy coding unit 56 may adapt the VLC table such that codewords assigned to the various combinations of motion direction and sub-integer pixel precision for motion vectors have bit lengths that are inversely proportional to the relative likelihood of the combination of motion direction and sub-integer pixel precision for a motion vector being used for a block. In this manner, the signaling of motion direction and sub-integer pixel precision for motion vectors of blocks may provide a bit savings relative to signaling motion vector sub-integer pixel precision direction (e.g., using a one-bit flag for each motion vector to indicate whether the motion vector has one-quarter pixel precision or one-eighth pixel precision).

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame store 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame store 64. The reconstructed video block may be used by motion estimation unit 42 and motion compensation unit 44 as a reference block to inter-code a block in a subsequent video frame.

Video encoder 20 therefore represents an example of a video encoder configured to encode a block of video data using a motion vector that refers to a reference frame in one of a plurality of sets of reference frames with a selected sub-integer pixel precision, generate a value representative of the selected sub-integer pixel precision for the motion vector based on the one of the plurality of sets of reference frames referred to by the motion vector, and output the encoded block and the generated value representative of the selected sub-integer pixel precision for the motion vector.

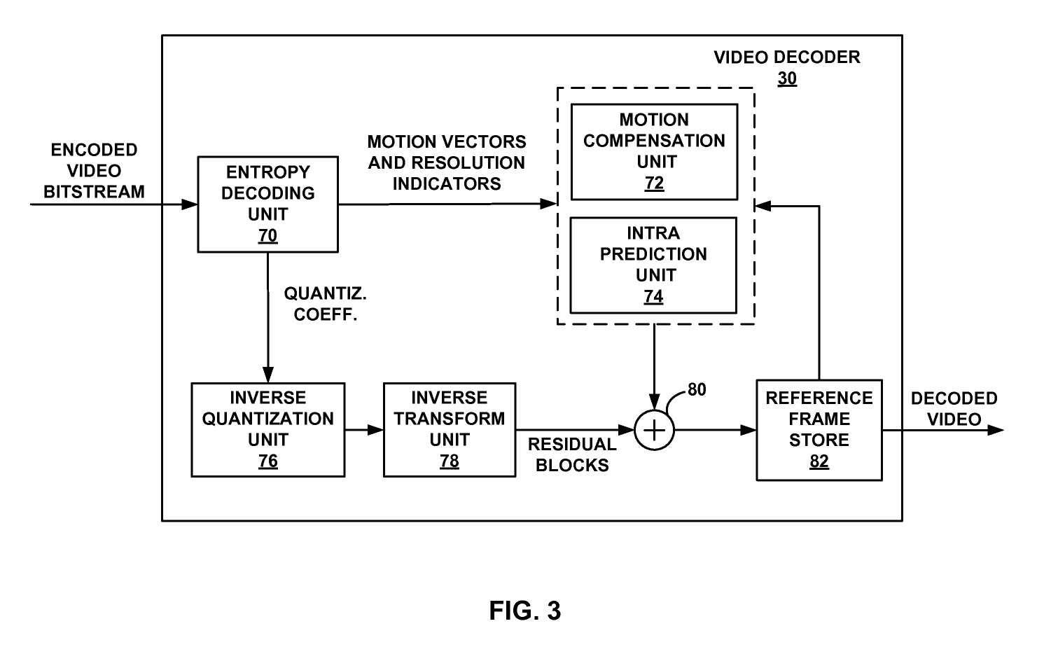

FIG. 3 is a block diagram illustrating an example of video decoder 30, which decodes an encoded video sequence using techniques for determining sub-integer pixel precision of motion vectors based on motion direction. In the example of FIG. 3, video decoder 30 includes an entropy decoding unit 70, motion compensation unit 72, intra prediction unit 74, inverse quantization unit 76, inverse transformation unit 78, reference frame store 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

Entropy decoding unit 70 may receive an encoded bitstream, e.g., via network, broadcast, or from a physical medium. The encoded bitstream may include entropy coded video data. In accordance with the techniques of this disclosure, the entropy coded video data may include codewords representative of sub-integer pixel precision for motion vectors based on a motion direction for the motion vectors. Entropy decoding unit 70 may store a VLC table substantially similar to a VLC table stored by entropy coding unit 56 of video encoder 20 (FIG. 2). Accordingly, entropy decoding unit 70 may refer to the VLC table using a received codeword to determine a sub-integer pixel precision for a motion vector based on a motion direction for the motion vector. In some examples, the codeword may further indicate the motion direction for the motion vector, in addition to the sub-integer pixel precision for the motion vector.

Motion compensation unit 72 may use motion vectors received in the bitstream to identify a predictive block in reference frames of reference frame store 82. Moreover, motion compensation unit 72 may receive an indication of a sub-integer pixel precision for the motion vectors from entropy decoding unit 70, and in some examples, an indication of a set of reference frames in which a reference frame referred to by the motion vector is found. Motion compensation unit 72 may retrieve a reference block from the reference frame identified by the motion vector. When the motion vector has sub-integer pixel precision, motion compensation unit 72 may calculate (e.g., interpolate) values for sub-integer pixels at the precision of the motion vector to retrieve the reference block. The reference block may serve as a predicted value for a current block of a current frame.

Intra prediction unit 74 may use intra prediction modes received in the bitstream to form a prediction block from spatially adjacent blocks. Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard. The inverse quantization process may also include use of a quantization parameter QP_{Y} calculated by video encoder 20 for each macroblock to determine a degree of quantization and, likewise, a degree of inverse quantization that should be applied.

Inverse transform unit 58 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters to interpolate values for sub-integer pixel positions of a reference frame. Motion compensation unit 72 may use interpolation filters as used by video encoder 20 during encoding of the video block to calculate interpolated values for sub-integer pixel positions of a reference block. Motion compensation unit 72 may determine the interpolation filters used by video encoder 20 according to received syntax information and use the interpolation filters to produce predictive blocks.

Motion compensation unit 72 uses some of the syntax information to determine sizes of macroblocks used to encode frame(s) of the encoded video sequence, partition information that describes how each macroblock of a frame of the encoded video sequence is partitioned, modes indicating how each partition is encoded, one or more reference frames (or lists) for each inter-encoded macroblock or partition, and other information to decode the encoded video sequence.

Summer 80 sums the residual blocks with the corresponding prediction blocks generated by motion compensation unit 72 or intra-prediction unit to form decoded blocks. If desired, a deblocking filter may also be applied to filter the decoded blocks in order to remove blockiness artifacts. The decoded video blocks are then stored in reference frame store 82, which provides reference blocks for subsequent motion compensation and also produces decoded video for presentation on a display device (such as display device 32 of FIG. 1).

Video decoder 30 therefore represents an example of a video decoder configured to receive an encoded block of video data, a motion vector for the encoded block of video data, and a value corresponding to the motion vector, wherein the motion vector refers to a reference frame in one of a plurality of sets of reference frames, determine a sub-integer pixel precision for the motion vector and the one of the plurality of sets of reference frames based on the received value corresponding to the motion vector, and decode the encoded block of video data relative to the reference frame in the determined one of the plurality of sets of reference frames using the motion vector, based on the determined sub-integer pixel precision for the motion vector.

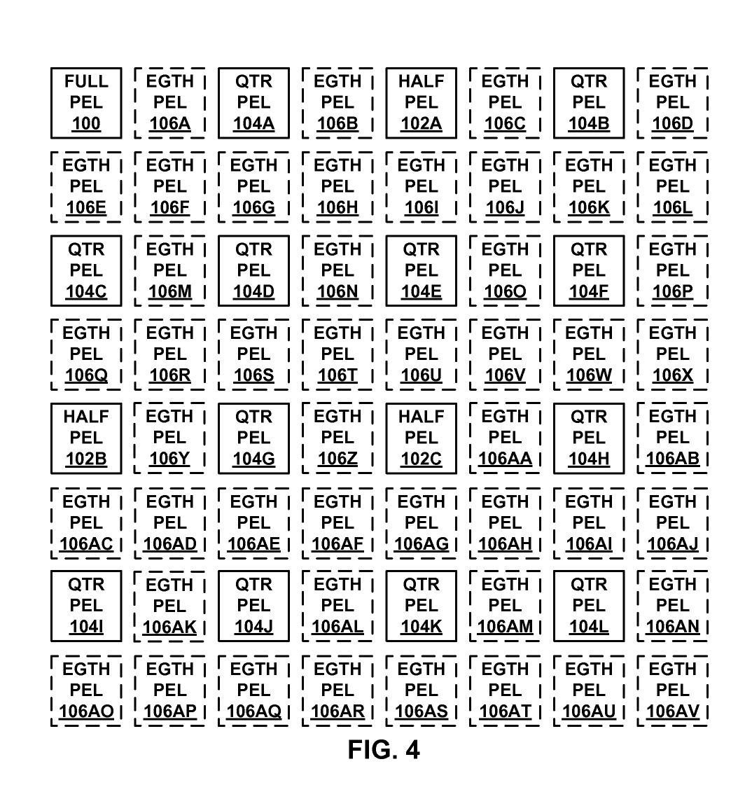

FIG. 4 is a conceptual diagram illustrating fractional pixel positions for a full pixel position. In particular, FIG. 4 illustrates fractional pixel positions for full pixel (pel) 100. Full pixel 100 corresponds to half-pixel positions 102A-102C (half pels 102), quarter pixel positions 104A-104L (quarter pels 104), and one-eighth-pixel positions 106A-106AV (egth pels 106).

FIG. 4 illustrates eighth pixel positions 106 of a block using dashed outlining to indicate that these positions may be optionally included. That is, if a motion vector has one-eighth-pixel precision, the motion vector may point to any of full pixel position 100, half pixel positions 102, quarter pixel positions 104, or eighth pixel positions 106. However, if the motion vector has one-quarter-pixel precision, the motion vector may point to any of full pixel position 100, half pixel positions 102, or quarter pixel positions 104, but would not point to eighth pixel positions 106. It should further be understood that in other examples, other precisions may be used, e.g., one-sixteenth pixel precision, one-thirty-second pixel precision, or the like.

A value for the pixel at full pixel position 100 may be included in a corresponding reference frame. That is, the value for the pixel at full pixel position 100 generally corresponds to the actual value of a pixel in the reference frame, e.g., that is ultimately rendered and displayed when the reference frame is displayed. Values for half pixel positions 102, quarter pixel positions 104, and eighth pixel positions 106 (collectively referred to as fractional pixel positions) may be interpolated using adaptive interpolation filters or fixed interpolation filters, e.g., filters of various numbers of “taps” (coefficients) such as various Wiener filters, bilinear filters, or other filters. In general, the value of a fractional pixel position may be interpolated from one or more neighboring pixels, which correspond to values of neighboring full pixel positions or previously determined fractional pixel positions.

In accordance with the techniques of this disclosure, a motion vector may have either one-quarter pixel precision or one-eighth pixel precision. By receiving a signal indicative of sub-integer pixel precision for a motion vector, a video decoder may determine which of the fractional pixel positions (half pixel positions 102, quarter pixel positions 104, and eighth pixel positions 106 in this example) need interpolated values. If a motion vector has quarter-pixel precision, for example, a video decoder need not interpolate values for eighth pixel positions 106. The video decoder may further use the signal indicative of the sub-integer pixel precision of a motion vector to decode an encoded representation of the motion vector, e.g., relative to a motion predictor for the motion vector. The motion predictor may be selected as one of the motion vectors from spatial and/or temporal neighboring blocks to a current block. In accordance with the techniques of this disclosure, the signal may additionally provide information on whether the encoded motion vector refers to a reference frame in list 0 or list 1.

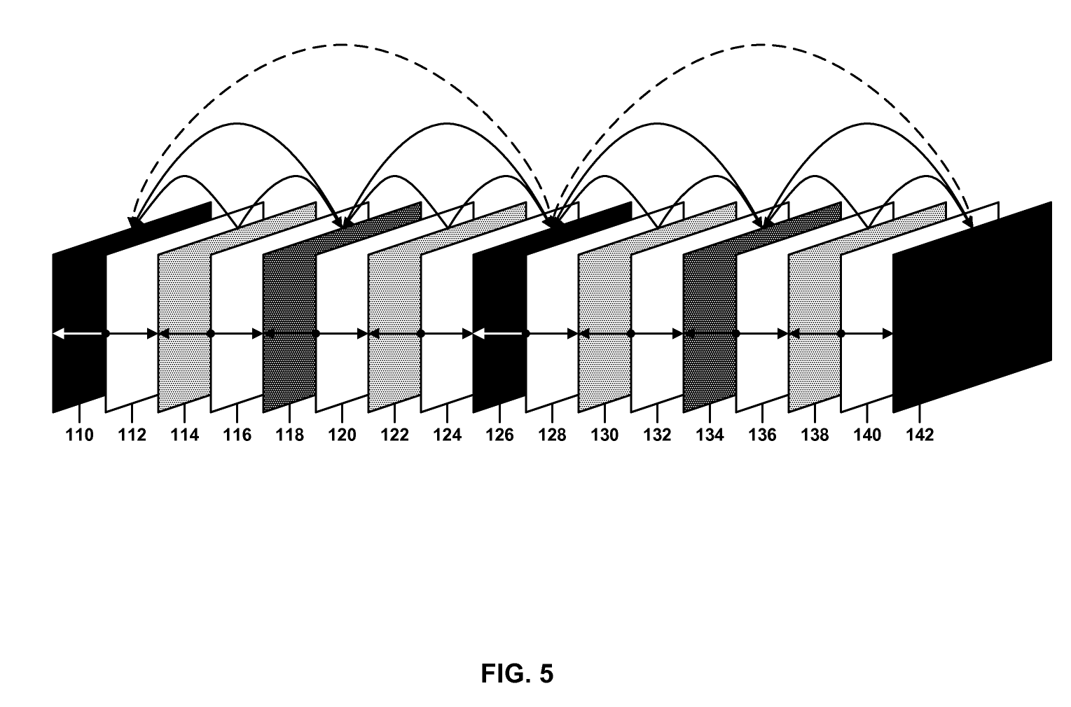

FIG. 5 is a conceptual diagram illustrating a sequence of coded video frames 110-142. The frames are shaded differently to indicate relative positions within a hierarchical prediction structure. For example, frames 110, 126, and 142 are shaded black to represent that frames 110, 126, 142 are at the top of the hierarchical prediction structure. Frames 110, 126, 142 may comprise, for example, intra-coded frames or inter-coded frames that are predicted from other frames in a single direction (e.g., P-frames). When intra-coded, frames 110, 126, 142 are predicted solely from data within the same frame. When inter-coded, frame 126, for example, may be coded relative to data of frame 110, as indicated by the dashed arrow from frame 126 to frame 110.

Frames 118, 134 are darkly shaded to indicate that they are next in the encoding hierarchy following frames 110, 126, and 142. Frames 118, 134 may comprise bi-directional, inter-mode prediction encoded frames. For example, frame 118 may be predicted from data of frames 110 and 126, while frame 134 may be predicted from frames 126 and 142.

Frames 114, 122, 130, and 138 are lightly shaded to indicate that they are next in the encoding hierarchy following frames 118 and 134. Frames 114, 122, 130, and 138 may also comprise bi-directional, inter-mode prediction encoded frames. In general, frames that are lower in the encoding hierarchy may be encoded relative to any of the frames higher in the encoding hierarchy, so long as the frames are still stored in a reference frame buffer. For example, frame 114 may be predicted from frames 110 and 118, frame 122 may be predicted from frames 118 and 126, frame 130 may be predicted from frame 126 and 134, and frame 138 may be predicted from frame 134 and 142. In addition, it should be understood that blocks of frame 114 may also be predicted from frame 110 and frame 126. Likewise, it should be understood that blocks of frame 122 may be predicted from frames 110 and 126.

Frames 112, 116, 120, 124, 128, 132, 136, and 140 are white to indicate that these frames are lowest in the encoding hierarchy. Frames 112, 116, 120, 124, 128, 132, 136, and 140 may be bi-directional, inter-mode prediction encoded frames. Frame 112 may be predicted from frames 110 and 114, frame 116 may be predicted from frames 114 and 118, frame 120 may be predicted from frames 118 and 122, frame 124 may be predicted from frames 122 and 126, frame 128 may be predicted from frame 126 and 130, frame 132 may be predicted from frames 130 and 134, frame 136 may be predicted from frames 134 and 138, and frame 140 may be predicted from frames 138 and 142. Again, it should be understood that for a frame at hierarchical level N+1, the frame may be predicted from any of the frames at any of levels 0-N, so long as the frames are still stored in the reference frame buffer. The number of frames stored in the reference frame buffer may vary depending on profile and/or level requirements specified in the bistream, e.g., by a video encoder.

Frames 110-142 are illustrated in display order. That is, following decoding, frame 110 is displayed before frame 112, frame 112 is displayed before frame 114, and so on. However, due to the encoding hierarchy, frames 110-142 may be decoded in a different order. Moreover, after being encoded, frames 110-142 may be arranged in decoding order in a bitstream including encoded data for frames 110-142. For example, frame 126 may be displayed after frames 110-124. However, due to the encoding hierarchy, frame 126 may be decoded and placed in the bistream before frames 110-124. That is, in order to properly decode frame 118, for example, frame 126 may need to be decoded first, in order to act as a reference frame for frame 118. Likewise, frame 118 may act as a reference frame for any of frames 112-116 and 120-124, and therefore may need to be decoded before frames 112-116 and 120-124.

The time at which a frame is displayed may be referred to as presentation time or a display time, whereas the time at which the frame is decoded may be referred to as decoding time. Presentation/display times generally provide indications of temporal ordering relative to other frames of the same sequence. A current frame may be predicted from any reference frame having a decoding time earlier than the current frame (assuming the reference frame is still stored in the reference frame buffer, e.g., reference frame store 64 (FIG. 2) or reference frame store 82 (FIG. 3)). When a reference frame has a display time earlier than the current frame, the reference frame may be stored in list 0, whereas when the reference frame has a display time later than the current frame, the reference frame may be stored in list 1.

A block of a current frame may be inter-prediction mode encoded relative to a reference frame having a display time earlier or later than the current frame (uni-directional prediction) or both a reference frame having a display time earlier than the current frame and a reference frame having a display time later than the current frame (bi-directional prediction). For example, a block of frame 132 of FIG. 5 may be predicted from a reference block of frame 130 (thus having an earlier display time), a block of frame 134 (thus having a later display time), or be bi-directionally predicted from a reference block of frame 130 and a block of frame 134. Motion vectors may provide indications of the locations of the reference blocks, and may further have adaptive sub-integer pixel precision, e.g., either one-quarter pixel precision or one-eighth pixel precision. In accordance with the techniques of this disclosure, an indication of the sub-integer pixel precision for a motion vector of the block of the current frame may be provided based on whether the block is predicted relative to a reference frame having an earlier display time or a later display time, or bi-directionally predicted relative to earlier and later display-time reference frames.

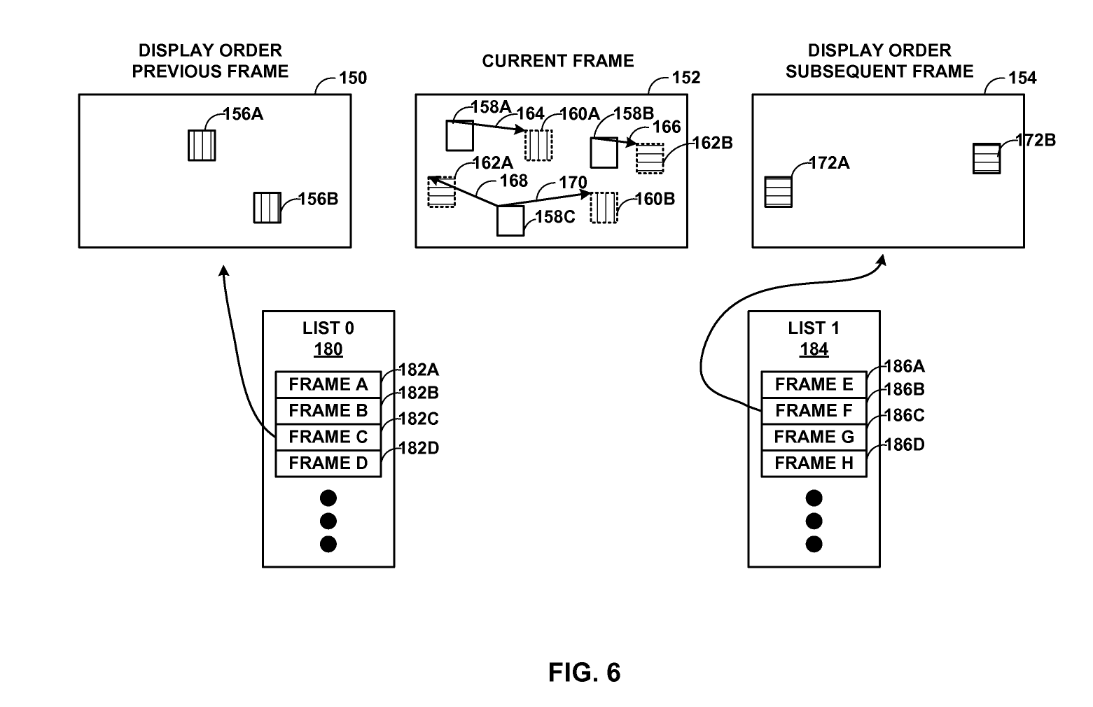

FIG. 6 is a conceptual diagram illustrating a current frame 152 including blocks predicted from reference blocks of a display order previous frame 150 and a display order subsequent frame 154. In particular, in this example, current frame 152 includes blocks 158A-158C. Block 158A is encoded using motion vector 164. Motion vector 164 refers to reference block 156A of previous frame 150. Accordingly, reference block 156A provides a predicted value for block 158A.

Block 160A represents the location of block 156A if block 156A were within current frame 152. However, block 160A is illustrated with a dashed outline to indicate that motion vector 164 actually refers to block 156A of previous frame 150, not current frame 152. Block 160A is intended only to represent the corresponding location of block 156A relative to block 158A in current frame 152. In this manner, motion vector 164 refers to a reference frame having a display time that is earlier than current frame 152.

Current frame 152 also includes block 158B, which is predicted from reference block 172B of display order subsequent frame 154. Again, block 162B of current frame 152 provides an indication of the location of block 172B relative to block 158B. Motion vector 166 of block 158B refers to block 172B. In this manner, motion vector 166 refers to a reference frame having a display time that is later than current frame 152.

Current frame 152 further includes block 158C. Block 158C, in this example, is bi-directionally predicted. That is, block 158C is predicted using motion vector 168 that refers to block 172A of subsequent frame 154, and also using motion vector 170 that refers to block 156B of previous frame 150. Block 162A represents the location of block 172A in current frame 152, while block 160B represents the location of block 156B in current frame 152. In this manner, block 158C is bi-directionally predicted. That is, block 158C is predicted from both a reference frame having a display time earlier than current frame 152 and a reference frame having a display time later than current frame 152. The values of blocks 172A and 156B may be combined to form a predicted value for block 158C.

FIG. 6 also illustrates list 0 180 and list 1 184, each of which represents a respective set of reference frames. List 0 180 includes identifiers 182A-182D (identifiers 182) to reference frames having display times earlier than current frame 152. Likewise, list 1 184 includes identifiers 186A-186D (identifiers 186) to reference frames having display times later than current frame 152. For example, frame C identifier 182C refers to previous frame 150, while frame F identifier 186B refers to subsequent frame 154. The other frames referred to by identifiers 182A, 182B, 182D, 186A, 186C, and 186D are not illustrated in FIG. 6.

Motion vectors 164, 166, 168, and 170 may have sub-integer pixel precision. Motion vectors 164, 166, 168, and 170 need not each have the same sub-integer pixel precision. For example, motion vectors 164, 166 may have quarter-pixel precision, while motion vectors 168, 170 may have eighth-pixel precision. Similarly, motion vectors for a bi-directionally predicted block may have different sub-integer pixel precisions. For example, motion vector 168 may have quarter-pixel precision, while motion vector 170 may have eighth-pixel precision.

In accordance with the techniques of this disclosure, a video encoder (such as video encoder 20) that encodes frames 150, 152, 154 may provide an indication of sub-integer pixel precision for motion vectors 164, 166, 168, and 170 based on motion direction for corresponding blocks 158. A codeword selected from a VLC table may comprise the indication of the sub-integer pixel precision for a motion vector, as well as an indication of whether the motion vector refers to a reference frame in list 0 180 or list 1 184. The motion direction for block 158A in this example corresponds to block 158A being predicted from reference block 156A of display order previous frame 150. The motion direction for block 158B in this example corresponds to block 158B being predicted from reference block 172B of display order subsequent frame 154. The motion direction for block 158C in this example corresponds to block 158C being bi-directionally predicted from both reference block 156B of display order previous frame 150 and reference block 172A of display order subsequent frame 154.

Video encoder 20 may therefore select a codeword to represent the sub-integer pixel precision of motion vector 164 based on motion vector 164 referring to block 156A of previous frame 150, that is, a reference frame corresponding to list 0 180. The codeword may further represent that motion vector 164 refers to a reference frame corresponding to list 0 180. Motion vector 164 may include an index that into a reference frame list, where the index may refer to the position of frame C identifier 182C, in this example. Similarly, video encoder 20 may select a codeword to represent the sub-integer pixel precision of motion vector 166 based on motion vector 166 referring to block 172B of subsequent frame 154, which corresponds to list 1 184. Likewise, video encoder 20 may select a codeword to represent sub-integer pixel precisions for both of motion vectors 168 and 170, based on motion vectors 168 and 170 being used to bi-directionally predict block 158C of current frame 152.

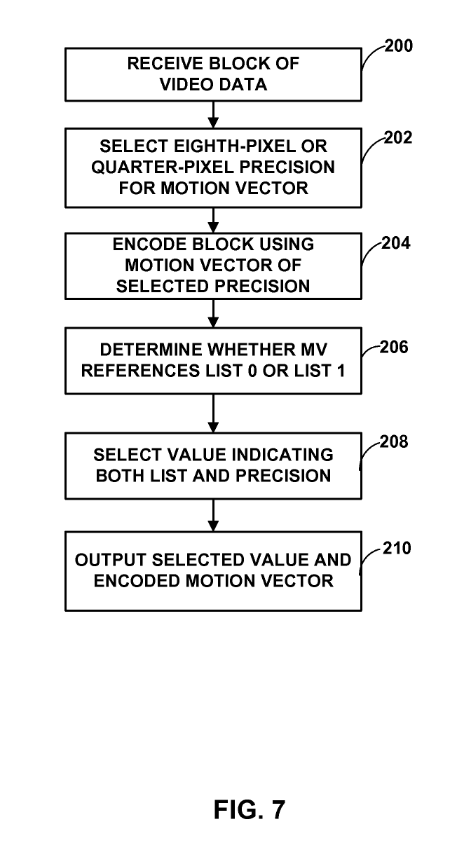

FIG. 7 is a flowchart illustrating an example method for providing an indication of a sub-integer pixel precision for a motion vector based on motion direction of the motion vector. Although described with respect to the example of video encoder 20 of FIGS. 1 and 2, it should be understood that other video encoding devices, units, and processor may be configured to perform the techniques of FIG. 7. Moreover, additional or alternative steps may be performed, or certain steps may be performed in a different order, without departing from the techniques of FIG. 7. Although generally described with respect to providing an indication of a sub-integer pixel precision for a motion vector of a block in a frame, it should be understood that these techniques may also apply to providing an indication of a sub-integer pixel precision for a motion vector of a block in a slice of a frame.

Initially, video encoder 20 may receive a block of video data (200). The block may form part of a current frame. For purposes of example, it is assumed that the current frame is to be encoded using inter-prediction mode encoding, e.g., uni-directional or bi-directional inter-prediction mode encoding. Accordingly, the frame may comprise a P-frame or a B-frame. Resolution selection unit 48 may then determine a sub-integer pixel precision for a motion vector used to encode the block. In the example of FIG. 7, resolution selection unit 48 may select between one-eighth pixel precision or one-quarter pixel precision for a motion vector to be used to encode the block (202). However, it should be understood that in other examples, other precisions may be selected.

In one example, to select between one-quarter pixel precision and one-eighth pixel precision, motion estimation unit 42 may perform a first motion search using one-quarter pixel precision motion vectors for the block, and a second motion search using one-eighth pixel precision motion vectors for the block. Motion estimation unit 42 may provide error values for prediction units resulting from each motion search to resolution selection unit 48. The error values may comprise error values produced by pixel differences between the block to be coded and the predicted block. For example, motion estimation unit 42 may calculate the error values using a sum of absolute differences (SAD), sum of squared differences (SSD), mean absolute difference (MAD), mean squared difference (MSD), or another error calculation method. Resolution selection unit 48 may then compare bitrates required for using each potential sub-integer pixel precision to distortion caused by each to select a motion vector resolution that has the relatively best rate-distortion properties.

Resolution selection unit 48 may send an indication of the selected sub-integer pixel precision to motion estimation unit 42, which may cause motion estimation unit 42 to send a motion vector of the selected precision for the block to motion compensation unit 44. Data for the motion vector may also indicate a reference frame of reference frame store 64 to which the motion vector refers, including an indication of whether the motion vector refers to list 0 or list 1. Video encoder 20 may then encode the block using the motion vector of the selected precision (204).

For example, motion compensation unit 44 may retrieve a reference block from the reference frame indicated by the data for the motion vector, and pass the reference block as a predicted value for the block being encoded to summer 50. As described above, summer 50 may calculate a residual for the block being encoded as a difference between the original block and the predicted block, and pass the residual block to transform unit 52, which may cause transform unit 52 to transform the block, and cause quantization unit 54 to quantize transform coefficients of the transformed block. As discussed above, list 0 and list 1 each comprise different sets of reference frames. Accordingly, in this manner, video encoder 20 may encode a block of video data using a motion vector that refers to a reference frame in one of a plurality of sets of reference frames with a selected sub-integer pixel precision.

Motion estimation unit 42 may also pass data for the motion vector of the block to entropy coding unit 56. Entropy coding unit 56 may determine whether the motion vector references a reference frame of list 0 or list 1 of reference frame store 64 (206). Based on this determination, entropy coding unit 56 may select a value that indicates the sub-integer pixel precision of the motion vector based, at least in part, on whether the motion vector references a reference frame of list 0 or list 1. In the example of FIG. 7, entropy coding unit 56 may select a value that indicates both the sub-integer pixel precision for the motion vector and the list including the reference frame referred to by the motion vector (208).

For example, entropy coding unit 56 may retrieve a codeword from a VLC table that associates codewords with possible sub-integer pixel precisions of motion vectors and sets of reference frames to which the motion vectors may refer (e.g., list 0 and list 1). The VLC table may resemble any of the examples of Tables 1-5, above. In this manner, entropy coding unit 56 may generate a value representative of the selected sub-integer pixel precision for the motion vector based on the one of the plurality of sets of reference frames referred to by the motion vector. Entropy coding unit 56 may also entropy encode other data for the motion vector, e.g., a horizontal component, a vertical component, and an index into the set of reference frames (e.g., list 0 or list 1).

Entropy coding unit 56 may then output the selected value (e.g., the codeword) and the encoded motion vector (210). Entropy coding unit 56 may also receive quantized transform coefficients from quantization unit 54, scan the quantized transform coefficients, entropy code the scanned, quantized transform coefficients, and then output the entropy coded coefficients. Outputting may include, for example, entropy coding unit 56 sending the entropy coded data to an interface that may transmit the entropy coded data over a network, store the entropy coded data to a computer-readable storage medium such as a hard disk, DVD, Blu-ray disc, flash drive, broadcast the entropy coded data over radio waves, transmit the entropy coded data to a satellite or radio tower for broadcasting, immediately providing the entropy coded data to a decoder (e.g., for testing purposes) or other forms of data output. In this manner, video encoder 20 may output the encoded block and the generated value representative of the selected sub-integer pixel precision for the motion vector.

Accordingly, the method of FIG. 7 may include encoding a block of video data using a motion vector that refers to a reference frame in one of a plurality of sets of reference frames with a selected sub-integer pixel precision, generating a value representative of the selected sub-integer pixel precision for the motion vector based on the one of the plurality of sets of reference frames referred to by the motion vector, and outputting the encoded block and the generated value representative of the selected sub-integer pixel precision for the motion vector.

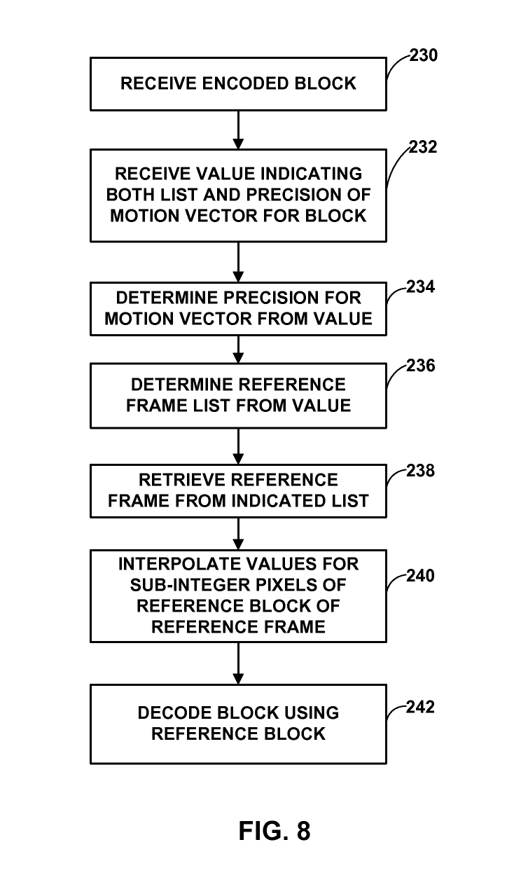

FIG. 8 is a flowchart illustrating an example method for decoding video data including indications of motion vector precision based on motion direction. Although described with respect to the example of video decoder 30 of FIGS. 1 and 3, it should be understood that other video decoding devices, units, and processor may be configured to perform the techniques of FIG. 8. Moreover, additional or alternative steps may be performed, or certain steps may be performed in a different order, without departing from the techniques of FIG. 8. Although generally described with respect to receiving an indication of a sub-integer pixel precision for a motion vector of a block in a frame, it should be understood that these techniques may also apply to receiving an indication of a sub-integer pixel precision for a motion vector of a block in a slice of a frame.

Initially, video encoder 20 may receive an encoded block of video data (230). For purposes of example, it is assumed that the block is encoded in an inter-prediction mode, e.g., uni-directional or bi-directional inter-prediction mode encoded. Accordingly, the block may be encoded with a motion vector that refers to a reference frame of a set of reference frames, such as a set of reference frames having display times earlier than the frame that includes the encoded block (e.g., list 0), or a set of reference frames having display times later than the frame that includes the encoded block (e.g., list 1). Likewise, the block may be encoded with two motion vectors, one motion vector referring to list 0 and another motion vector referring to list 1.

In addition, video encoder 20 may receive a value for the block that provides indication of the list of reference frames to which the motion vector refers, as well as an indication of sub-integer pixel precision of the motion vector for the block (232). For example, the value may comprise a VLC codeword. In this manner, video decoder 30 may receive an encoded block of video data, a motion vector for the encoded block of video data, and a value corresponding to the motion vector, wherein the motion vector refers to a reference frame in one of a plurality of sets of reference frames.

Entropy decoding unit 70 may then determine the sub-integer pixel precision for the motion vector from the value (234). Entropy decoding unit 70 may also determine the reference frame list to which the motion vector refers from the value (236). For example, a VLC table stored by entropy decoding unit 70 may include a list of codewords and indications of motion vector sub-integer pixel precisions and indications of lists of reference frames (e.g., list 0 or list 1) for a motion vector corresponding to each codeword. The VLC table may resemble any of the examples of Tables 1-5, above. By locating the received codeword in the VLC table, entropy decoding unit 70 may extract the corresponding sub-integer pixel precision and list of reference frames for the motion vector of the received block. In this manner, video decoder 30 may determine a sub-integer pixel precision for the motion vector and the one of the plurality of sets of reference frames based on the received value corresponding to the motion vector.

Entropy decoding unit 70 may send the indications of the list of reference frames to which the motion vector refers and the sub-integer pixel precision for the motion vector, as well as data for the motion vector (e.g., a horizontal component, a vertical component, and an index into the list of reference frames) to motion compensation unit 72. Motion compensation unit 72 may retrieve a reference frame from reference frame store 82 using the data received by entropy decoding unit 70 (238). For example, motion compensation unit 72 may retrieve the reference frame corresponding to the index for the motion vector from the list of reference frames corresponding to the received value from reference frame store 82.

Based on the indicated sub-integer pixel precision, motion compensation unit 72 may interpolate values for sub-integer pixel positions of a reference block of the reference frame retrieved from the determined list of reference frames (240). For example, motion compensation unit 72 may determine a fractional pixel position to which the motion vector refers using the horizontal and vertical components of the motion vector, along with the indication of the sub-integer pixel precision for the motion vector. If the motion vector has one-quarter pixel precision, and the motion vector refers to one-quarter pixel position 104D (FIG. 4), for example, motion compensation unit 72 may interpolate values for one-quarter pixel position 104D for each pixel in a reference block of the retrieved reference frame referred to by the motion vector. As another example, if the motion vector has one-eighth pixel precision, and the motion vector refers to one-eighth pixel position 106V, motion compensation unit 72 may interpolate values for one-eighth pixel position 106V for each pixel in a reference block of the retrieved reference frame referred to by the motion vector.

Video decoder 30 may then decode the received block using the reference block (242). For example, video decoder 30 may use the interpolated values for the sub-integer pixel positions of the reference block as a predicted value for the received block. Video decoder 30 may further receive an encoded residual value for the received block. Inverse quantization unit 76 may inverse quantize the encoded residual value, and inverse transform unit 78 may inverse transform the inverse quantized coefficients, to produce a matrix of coefficients in the pixel domain comprising the residual for the block. Motion compensation unit 72 may provide the reference block to summer 80, while inverse transform unit 78 may provide the matrix to summer 80. Summer 80 may add the predicted value and the residual to reproduce the block. In this manner, video decoder 30 may decode the encoded block of video data relative to the reference frame in the determined one of the plurality of sets of reference frames using the motion vector, based on the determined sub-integer pixel precision for the motion vector.

Accordingly, the method of FIG. 8 may include receiving an encoded block of video data, a motion vector for the encoded block of video data, and a value corresponding to the motion vector, wherein the motion vector refers to a reference frame in one of a plurality of sets of reference frames, determining a sub-integer pixel precision for the motion vector and the one of the plurality of sets of reference frames based on the received value corresponding to the motion vector, and decoding the encoded block of video data relative to the reference frame in the determined one of the plurality of sets of reference frames using the motion vector, based on the determined sub-integer pixel precision for the motion vector.

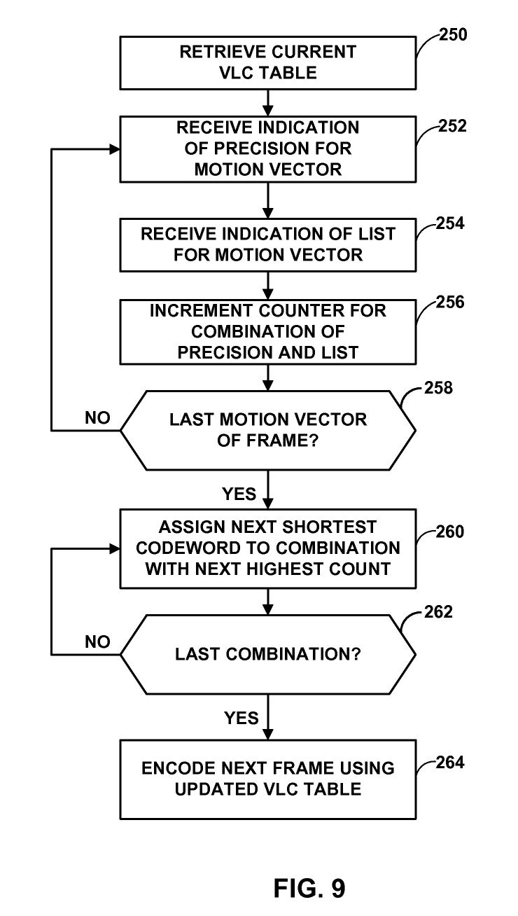

FIG. 9 is a flowchart illustrating an example method for adapting a VLC table based on statistics for symbols encoded using the VLC table. Although described as being performed by video encoder 20 for purposes of example, it should be understood that other video encoding and decoding devices may be configured to perform the techniques of FIG. 9. For example, video decoder 30 may perform similar techniques to calculate statistics for received codewords, which may be used to update the VLC table for a subsequent frame or slice.

Initially, entropy coding unit 56 may retrieve a current VLC table (250). The VLC table may have been generated based on a set of training statistics or a previously coded frame or slice. Entropy coding unit 56 may use the current VLC table when providing values indicative of sub-integer pixel precision for a motion vector and a set of reference frames referred to by the motion vector, e.g., in accordance with the method of FIG. 7. Entropy coding unit 56 may therefore, while encoding a current frame with the current VLC table, receive an indication of sub-integer pixel precision for a motion vector (252) and an indication of a list of reference frames referred to by the motion vector (254).

Entropy coding unit 56 may also maintain counters for each possible combination of sub-integer pixel precision and motion direction for blocks of the current frame or slice that are encoded in an inter-prediction mode. For example, assuming that motion vectors may have sub-integer pixel precision of either one-quarter pixel precision or one-eighth pixel precision, entropy coding unit 56 may maintain counters for each combination of one-quarter pixel precision or one-eighth pixel precision and uni-directional prediction relative to a reference frame of list 0, uni-directional prediction relative to a reference frame of list 1, or bi-directional prediction. For bi-directional prediction, entropy coding unit 56 may maintain counters for scenarios in which both motion vectors having one-quarter pixel precision, both motion vectors have one-eighth pixel precision, the list 0 motion vector has one-quarter pixel precision while the list 1 motion vector has one-eighth pixel precision, and the list 0 motion vector has one-quarter pixel precision while the list 1 motion vector has one-eighth pixel precision.

After receiving an indication of a sub-integer pixel precision for a motion vector and an indication of the list referred to by the motion vector (or in the case of bi-directional prediction, the sub-integer pixel precision of each motion vector of a block and the list referred to by each motion vector of the block), entropy coding unit 56 may increment a counter representative of the combination of sub-integer pixel precision and motion direction (256). Entropy coding unit 56 may then determine whether the last motion vector of the current frame (or slice) has been encoded (258). If the last motion vector of the current frame (or slice) has not yet been encoded (“NO” branch of 258), entropy coding unit 56 may receive an indication of a sub-integer pixel precision for a next motion vector of the current frame (or slice) and an indication of a list referred to by the next motion vector.

After encoding the last motion vector of the frame (or slice) (“YES” branch of 258), entropy coding unit 56 may update the current VLC table based on the values of the counters maintained for the current frame (or slice). For example, entropy coding unit 56 may assign the next shortest (in terms of bit length) codeword to the combination of sub-integer pixel precision and motion direction having the next highest counter value (260). While the last combination of precision and motion direction have not yet been assigned a codeword (“NO” branch of 262), entropy coding unit 56 may continue assigning the next shortest codeword to the combination of sub-integer pixel precision and motion direction having the next highest counter value. After assigning a codeword to the last combination of sub-integer pixel precision and motion direction, entropy coding unit 56 may encode combinations of sub-integer pixel precision and motion direction for a next frame (or slice) using the updated VLC table (264).

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of encoding video data, the method comprising:
encoding a block of video data using a motion vector that refers to a reference frame in one of a plurality of sets of reference frames with a selected sub-integer pixel precision;
generating a value representative of the selected sub-integer pixel precision for the motion vector based on the one of the plurality of sets of reference frames referred to by the motion vector; and
outputting the encoded block and the generated value representative of the selected sub-integer pixel precision for the motion vector.

2. The method of claim 1, wherein the selected sub-integer pixel precision comprises one of one-quarter-pixel precision and one-eighth-pixel precision.

3. The method of claim 1, wherein the block comprises a block of a current frame, and wherein the sets of reference frames comprise a first list including reference frames having display times earlier than the current frame, and a second, different list including reference frames having display tames later than the current frame.

4. The method of claim 3, wherein generating the value comprises:
generating the value to represent the selected sub-integer pixel precision for the motion vector and the first list when the reference frame referred to by the motion vector has a display time earlier than the current frame; and
generating the value to represent the selected sub-integer pixel precision for the motion vector and the second list when the reference frame referred to by the motion vector has a display time later than the current frame.

5. The method of claim 3, wherein the motion vector comprises a first motion vector that refers to a reference frame in the first list, wherein the selected sub-integer pixel precision for the first motion vector comprises a first selected sub-integer pixel precision, wherein encoding the block further comprises encoding the block using the first motion vector and a second motion vector that refers to a reference frame in the second list with a second selected sub-integer pixel precision, and wherein generating the value comprises generating a value representative of the first selected sub-integer pixel precision and the second selected sub-integer pixel precision based on the block being encoded with the first and second motion vectors.

6. The method of claim 1, further comprising generating a set of values representative of possible combinations of sets of reference frames and sub-integer pixel precisions for motion vectors, such that the values in the set have bit lengths corresponding to determined probabilities of occurrence of the respective combinations,
wherein generating the value comprises selecting the value representative of the selected sub-integer pixel precision for the motion vector from the generated set of values.

7. The method of claim 6, further comprising:
calculating statistics for encoded blocks regarding numbers of occurrences of the possible combinations; and
altering the set of values representative of the possible combinations based on the calculated statistics such that the values in the altered set have bit lengths corresponding to the number of occurrences of the possible combinations of the calculated statistics.

8. An apparatus for encoding video data, the apparatus comprising a video encoder configured to encode a block of video data using a motion vector that refers to a reference frame in one of a plurality of sets of reference frames with a selected sub-integer pixel precision, generate a value representative of the selected sub-integer pixel precision for the motion vector based on the one of the plurality of sets of reference frames referred to by the motion vector, and output the encoded block and the generated value representative of the selected sub-integer pixel precision for the motion vector.

9. The apparatus of claim 8, wherein the block comprises a block of a current frame, and wherein the sets of reference frames comprise a first list including reference frames having display times earlier than the current frame and a second, different list including reference frames having display tames later than the current frame.

10. The apparatus of claim 9, wherein the video encoder is configured to generate the value to represent the selected sub-integer pixel precision for the motion vector and the first list when the reference frame referred to by the motion vector has a display time earlier than the current frame, and to generate the value to represent the selected sub-integer pixel precision for the motion vector and the second list when the reference frame referred to by the motion vector has a display time later than the current frame.

11. The apparatus of claim 9, wherein the motion vector comprises a first motion vector that refers to a reference frame in the first list, wherein the selected sub-integer pixel precision for the first motion vector comprises a first selected sub-integer pixel precision, wherein the video encoder is configured to encode the block using the first motion vector and a second motion vector that refers to a reference frame in the second list with a second selected sub-integer pixel precision, and wherein to generate the value, the video encoder is configured to generate a value representative of the first selected sub-integer pixel precision and the second selected sub-integer pixel precision based on the block being encoded with the first and second motion vectors.

12. The apparatus of claim 8, wherein the video encoder is configured to generate a set of values representative of possible combinations of sets of reference frames and sub-integer pixel precisions for motion vectors, such that the values in the set have bit lengths corresponding to determined probabilities of occurrence of the respective combinations, and wherein the video encoder is configured to select the value representative of the selected sub-integer pixel precision for the motion vector from the generated set of values.

13. The apparatus of claim 12, wherein the video encoder is configured to calculate statistics for encoded blocks regarding numbers of occurrences of the possible combinations, and alter the set of values representative of the possible combinations based on the calculated statistics such that the values in the altered set have bit lengths corresponding to the number of occurrences of the possible combinations of the calculated statistics.

14. The apparatus of claim 8, wherein the apparatus comprises at least one of:
an integrated circuit;
a microprocessor; and
a wireless communication device that includes the video encoder.

15. An apparatus for encoding video data, the apparatus comprising:
means for encoding a block of video data using a motion vector that refers to a reference frame in one of a plurality of sets of reference frames with a selected sub-integer pixel precision;
means for generating a value representative of the selected sub-integer pixel precision for the motion vector based on the one of the plurality of sets of reference frames referred to by the motion vector; and
means for outputting the encoded block and the generated value representative of the selected sub-integer pixel precision for the motion vector.

16. The apparatus of claim 15, wherein the block comprises a block of a current frame, and wherein the sets of reference frames comprise a first list including reference frames having display times earlier than the current frame and a second, different list including reference frames having display tames later than the current frame.

17. The apparatus of claim 16, wherein the means for generating the value comprises:
means for generating the value to represent the selected sub-integer pixel precision for the motion vector and the first list when the reference frame referred to by the motion vector has a display time earlier than the current frame; and
means for generating the value to represent the selected sub-integer pixel precision for the motion vector and the second list when the reference frame referred to by the motion vector has a display time later than the current frame.

18. The apparatus of claim 16, wherein the motion vector comprises a first motion vector that refers to a reference frame in the first list, wherein the selected sub-integer pixel precision for the first motion vector comprises a first selected sub-integer pixel precision, wherein the means for encoding the block further comprises means for encoding the block using the first motion vector and a second motion vector that refers to a reference frame in the second list with a second selected sub-integer pixel precision, and wherein the means for generating the value comprises means for generating a value representative of the first selected sub-integer pixel precision and the second selected sub-integer pixel precision based on the block being encoded with the first and second motion vectors.

19. The apparatus of claim 15, further comprising means for generating a set of values representative of possible combinations of sets of reference frames and sub-integer pixel precisions for motion vectors, such that the values in the set have bit lengths corresponding to determined probabilities of occurrence of the respective combinations,
wherein the means for generating the value comprises means for selecting the value representative of the selected sub-integer pixel precision for the motion vector from the generated set of values.

20. The apparatus of claim 19, further comprising:
means for calculating statistics for encoded blocks regarding numbers of occurrences of the possible combinations; and
means for altering the set of values representative of the possible combinations based on the calculated statistics such that the values in the altered set have bit lengths corresponding to the number of occurrences of the possible combinations of the calculated statistics.

21. A computer program product comprising a computer-readable storage medium having stored thereon instructions that, when executed, cause a processor of a device for encoding video data to:
encode a block of video data using a motion vector that refers to a reference frame in one of a plurality of sets of reference frames with a selected sub-integer pixel precision;
generate a value representative of the selected sub-integer pixel precision for the motion vector based on the one of the plurality of sets of reference frames referred to by the motion vector; and
output the encoded block and the generated value representative of the selected sub-integer pixel precision for the motion vector.

22. The computer program product of claim 21, wherein the block comprises a block of a current frame, and wherein the sets of reference frames comprise a first list including reference frames having display times earlier than the current frame and a second, different list including reference frames having display tames later than the current frame.

23. The computer program product of claim 22, wherein the instructions that cause the processor to generate the value comprise instructions that cause the processor to:
generate the value to represent the selected sub-integer pixel precision for the motion vector and the first list when the reference frame referred to by the motion vector has a display time earlier than the current frame; and
generate the value to represent the selected sub-integer pixel precision for the motion vector and the second list when the reference frame referred to by the motion vector has a display time later than the current frame.

24. The computer program product of claim 22, wherein the motion vector comprises a first motion vector that refers to a reference frame in the first list, wherein the selected sub-integer pixel precision for the first motion vector comprises a first selected sub-integer pixel precision, wherein the instructions that cause the processor to encode the block further comprises instructions that cause the processor to encode the block using the first motion vector and a second motion vector that refers to a reference frame in the second list with a second selected sub-integer pixel precision, and wherein the instructions that cause the processor to generate the value comprises instructions that cause the processor to generate a value representative of the first selected sub-integer pixel precision and the second selected sub-integer pixel precision based on the block being encoded with the first and second motion vectors.

25. The computer program product of claim 21, further comprising instructions that cause the processor to generate a set of values representative of possible combinations of sets of reference frames and sub-integer pixel precisions for motion vectors, such that the values in the set have bit lengths corresponding to determined probabilities of occurrence of the respective combinations,
wherein the instructions that cause the processor to generate the value comprise instructions that cause the processor to select the value representative of the selected sub-integer pixel precision for the motion vector from the generated set of values.

26. The computer program product of claim 25, further comprising instructions that cause the processor to:
calculate statistics for encoded blocks regarding numbers of occurrences of the possible combinations; and
alter the set of values representative of the possible combinations based on the calculated statistics such that the values in the altered set have bit lengths corresponding to the number of occurrences of the possible combinations of the calculated statistics.

27. A method of decoding video data, the method comprising:
receiving an encoded block of video data, a motion vector for the encoded block of video data, and a value corresponding to the motion vector, wherein the motion vector refers to a reference frame in one of a plurality of sets of reference frames;
determining a sub-integer pixel precision for the motion vector and the one of the plurality of sets of reference frames based on the received value corresponding to the motion vector; and
decoding the encoded block of video data relative to the reference frame in the determined one of the plurality of sets of reference frames using the motion vector, based on the determined sub-integer pixel precision for the motion vector.

28. The method of claim 27, wherein the sub-integer pixel precision comprises one of one-quarter-pixel precision and one-eighth-pixel precision.

29. The method of claim 27, wherein the encoded block comprises an encoded block of a current frame, and wherein the sets of reference frames comprise a first list including reference frames having display times earlier than the current frame and a second, different list including reference frames having display tames later than the current frame.

30. The method of claim 29, further comprising determining whether the reference frame referred to by the motion vector is in the first list or the second list based on the value corresponding to the motion vector.

31. The method of claim 27, further comprising receiving a set of values representative of possible combinations of sets of reference frames and sub-integer pixel precisions for motion vectors, such that the values in the set have bit lengths corresponding to probabilities of occurrence of the respective combinations,
wherein determining the sub-integer pixel precision for the motion vector and the one of the plurality of sets of reference frames comprises retrieving an indication of the sub-integer pixel precision and an indication of the one of the plurality of sets of reference frames that are represented by the received value that corresponds to the received motion vector in the received set of values.

32. An apparatus for decoding video data, the apparatus comprising a video decoder configured to receive an encoded block of video data, a motion vector for the encoded block of video data, and a value corresponding to the motion vector, wherein the motion vector refers to a reference frame in one of a plurality of sets of reference frames, determine a sub-integer pixel precision for the motion vector and the one of the plurality of sets of reference frames based on the received value corresponding to the motion vector, and decode the encoded block of video data relative to the reference frame in the determined one of the plurality of sets of reference frames using the motion vector, based on the determined sub-integer pixel precision for the motion vector.

33. The apparatus of claim 32, wherein the sub-integer pixel precision comprises one of one-quarter-pixel precision and one-eighth-pixel precision.

34. The apparatus of claim 32, wherein the encoded block comprises an encoded block of a current frame, and wherein the sets of reference frames comprise a first list including reference frames having display times earlier than the current frame and a second, different list including reference frames having display tames later than the current frame.

35. The apparatus of claim 34, wherein the video decoder is configured to determine whether the reference frame referred to by the motion vector is in the first list or the second list based on the received value corresponding to the motion vector.

36. The apparatus of claim 32, wherein the video decoder is configured to receive a set of values representative of possible combinations of sets of reference frames and sub-integer pixel precisions for motion vectors, such that the values in the set have bit lengths corresponding to probabilities of occurrence of the respective combinations,
wherein to determine the sub-integer pixel precision for the motion vector and the one of the plurality of sets of reference frames, the video decoder is configured to retrieve an indication of the sub-integer pixel precision and an indication of the one of the plurality of sets of reference frames that are represented by the received value corresponding to the received motion vector in the received set of values.

37. The apparatus of claim 32, wherein the apparatus comprises at least one of:
an integrated circuit;
a microprocessor; and
a wireless communication device that includes the video encoder.

38. An apparatus for decoding video data, the apparatus comprising:
means for receiving an encoded block of video data, a motion vector for the encoded block of video data, and a value corresponding to the motion vector, wherein the motion vector refers to a reference frame in one of a plurality of sets of reference frames;
means for determining a sub-integer pixel precision for the motion vector and the one of the plurality of sets of reference frames based on the received value corresponding to the motion vector; and
means for decoding the encoded block of video data relative to the reference frame in the determined one of the plurality of sets of reference frames using the motion vector, based on the determined sub-integer pixel precision for the motion vector.

39. The apparatus of claim 38, wherein the sub-integer pixel precision comprises one of one-quarter-pixel precision and one-eighth-pixel precision.

40. The apparatus of claim 38, wherein the encoded block comprises an encoded block of a current frame, and wherein the sets of reference frames comprise a first list including reference frames having display times earlier than the current frame and a second, different list including reference frames having display tames later than the current frame.

41. The apparatus of claim 40, further comprising means for determining whether the reference frame referred to by the motion vector is in the first list or the second list based on the value corresponding to the motion vector.

42. The apparatus of claim 38, further comprising means for receiving a set of values representative of possible combinations of sets of reference frames and sub-integer pixel precisions for motion vectors, such that the values in the set have bit lengths corresponding to probabilities of occurrence of the respective combinations,
wherein the means for determining the sub-integer pixel precision for the motion vector and the one of the plurality of sets of reference frames comprises means for retrieving an indication of the sub-integer pixel precision and an indication of the one of the plurality of sets of reference frames that are represented by the received value corresponding to the received motion vector in the received set of values.

43. A computer program product comprising a computer-readable storage medium having stored thereon instructions that, when executed, cause a processor of a device for decoding video data to:
receive an encoded block of video data, a motion vector for the encoded block of video data, and a value corresponding to the motion vector, wherein the motion vector refers to a reference frame in one of a plurality of sets of reference frames;
determine a sub-integer pixel precision for the motion vector and the one of the plurality of sets of reference frames based on the received value corresponding to the motion vector; and
decode the encoded block of video data relative to the reference frame in the determined one of the plurality of sets of reference frames using the motion vector, based on the determined sub-integer pixel precision for the motion vector.

44. The computer program product of claim 43, wherein the sub-integer pixel sub-integer pixel precision comprises one of one-quarter-pixel precision and one-eighth-pixel precision.

45. The computer program product of claim 43, wherein the encoded block comprises an encoded block of a current frame, and wherein the sets of reference frames comprise a first list including reference frames having display times earlier than the current frame and a second, different list including reference frames having display tames later than the current frame.

46. The computer program product of claim 45, further comprising determining whether the reference frame referred to by the motion vector is in the first list or the second list based on the value corresponding to the motion vector.

47. The computer program product of claim 43, further comprising receiving a set of values representative of possible combinations of sets of reference frames and sub-integer pixel precisions for motion vectors, such that the values in the set have bit lengths corresponding to probabilities of occurrence of the respective combinations,
wherein the means for determining the sub-integer pixel precision for the motion vector and the one of the plurality of sets of reference frames comprises means for retrieving an indication of the sub-integer pixel precision and an indication of the one of the plurality of sets of reference frames that are represented by the received value corresponding to the received motion vector in the received set of values.
